(19) United States
(12) Patent Application Publication
(10) Pub. No.: US 2020/0342627 A1
(43) Pub. Date: Oct. 29, 2020

(54) CAMERA CALIBRATION SYSTEM, CAMERA CALIBRATION METHOD, AND NON-TRANSITORY MEDIUM

(71) Applicant: HONGFUJIN PRECISION ELECTRONICS (TIANJIN) CO., LTD., Tianjin (CN)

(72) Inventors: SHIH CHUN WANG, New Taipei (TW); CHENG-YU WANG, New Taipei (TW); TING-YU DU, New Taipei (TW)

(21) Appl. No.: 16/517,920

(22) Filed: Jul. 22, 2019

(30) Foreign Application Priority Data
Apr. 23, 2019 (CN) 201910330319.3

(51) Int. Cl. G06T 7/80; G06T 7/73; B64C 39/02

(52) U.S. Cl. CPC G06T 7/80; G06T 7/73; B64C 2201/127; B64C 2201/123; B64C 39/024

(57) ABSTRACT

A camera calibration system includes a server, a camera communicatively coupled to the server, a drone communicatively coupled to the server, and an identification pattern coupled to the drone. The server controls the drone to fly in front of the camera at a calibration distance according to position and orientation information of the camera and position information and a distance setting rule of the drone, controls the camera to acquire at least one image of the identification pattern at each of the plurality of positions, and obtains parameters of the camera by performing calibration on the camera according to the acquired plurality of images. The drone flies in a number of positions at the calibration distance and flies in at least one plane.

### FIELD

The subject matter herein generally relates to camera calibration technology, and more particularly to a camera calibration system, a camera calibration method, and a non-transitory medium for calibrating a camera.

### BACKGROUND

Generally, in order to eliminate image distortion by a camera capturing an image, the camera needs to be calibrated. During calibration, multiple calibration plates are placed at different positions, the camera captures multiple images of the calibration plates in different positions, and parameters of the camera are calculated by comparing image coordinates of the calibration plates in the captured images and actual coordinates of the calibration plates. However, the calibration process needs to place the calibration plates at different positions, which may be time-consuming and laborious.

### BRIEF DESCRIPTION OF THE DRAWINGS

Implementations of the present disclosure will now be described, by way of embodiments, with reference to the attached figures.

FIG. 1 is a schematic diagram of an embodiment of a camera calibration system.

FIG. 2 is a block diagram of the camera calibration system in FIG. 1.

FIG. 3 is a flowchart of a camera calibration method.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising” means “including, but not necessarily limited to”; it specifically indicates open-ended inclusion or membership in a so-described combination, group, series and the like.

In general, the word “module” as used hereinafter refers to logic embodied in hardware or firmware, or to a collection of software instructions, written in a programming language such as, for example, Java, C, or assembly. One or more software instructions in the modules may be embedded in firmware such as in an erasable-programmable read-only memory (EPROM). It will be appreciated that the modules may comprise connected logic units, such as gates and flip-flops, and may comprise programmable units, such as programmable gate arrays or processors. The modules described herein may be implemented as either software and/or hardware modules and may be stored in any type of computer-readable medium or other computer storage device.

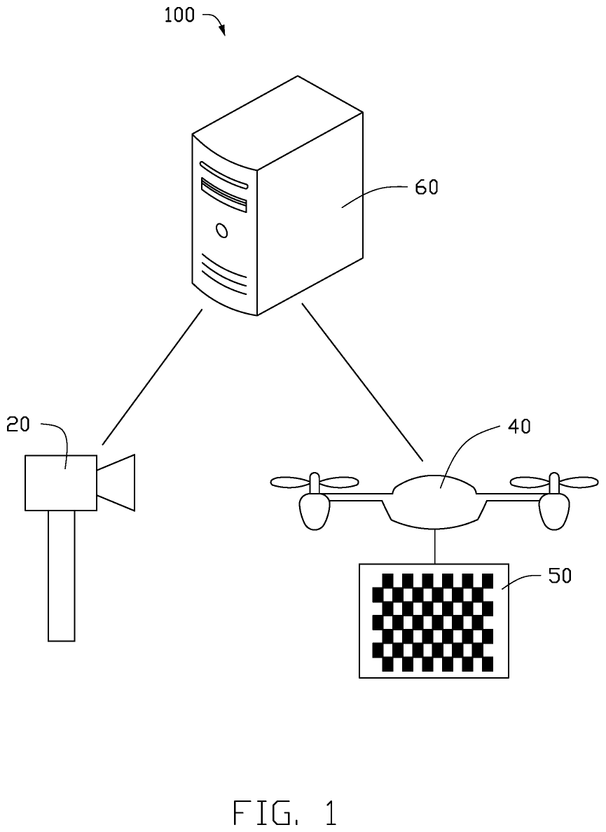

FIG. 1 shows an embodiment of a camera calibration system 100. The camera calibration system 100 includes at least one camera 20, a drone 40, an identification pattern 50, and a server 60. The camera calibration system 100 acquires parameters of the camera 20 and calibrates the camera 20 according to the parameters of the camera 20.

The identification pattern 50 includes, but is not limited to, a circular or square array pattern. In one embodiment, the identification pattern 50 is a checkerboard. The drone 40 is coupled to the identification pattern 50. In one embodiment, the identification pattern 50 is externally attached to the drone 40 through a connector. In other embodiments, the identification pattern 50 is directly embedded on the drone 40.

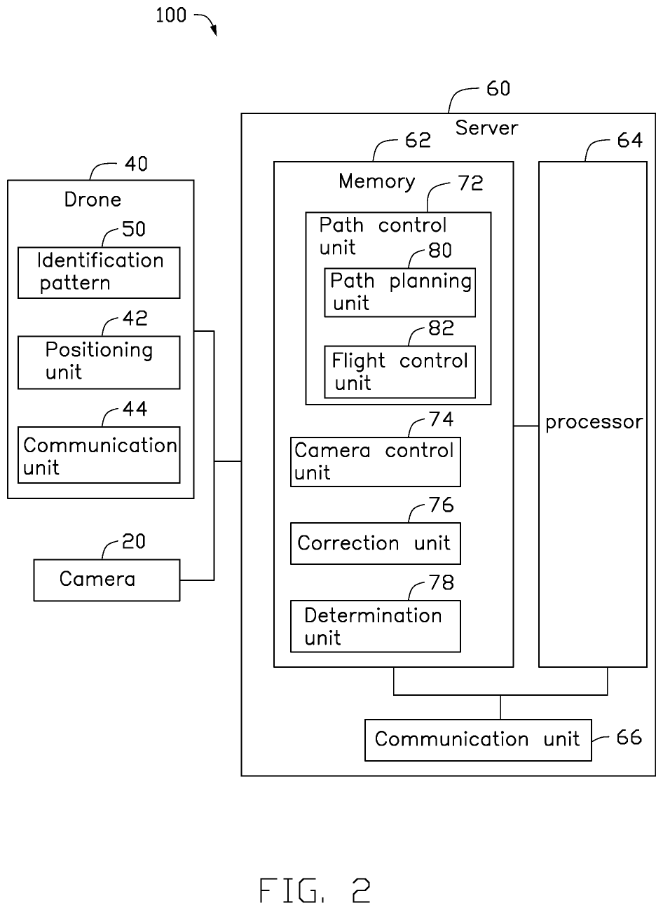

Referring to FIG. 2 simultaneously, the drone 40 includes a positioning unit 42 and a first communication unit 44. The positioning unit 42 acquires location information of the drone 40. The first communication unit 44 transmits the acquired location information of the drone 40 to the server 60.

The server 60 includes a memory 62, a processor 64, and a second communication unit 66 electrically coupled together. The memory 62 stores various types of data of the server 60 and a plurality of modules, which are executed by the processor 64 to carry out functions of the plurality of modules. The plurality of modules include a path control module 72, a camera control module 74, a calibration module 76, and a determination module 78. The processor 64 further calculates and processes various types of data of the server 60. The communication unit 66 communicatively couples the server 60 with the drone 40 and the camera 20.

The path control module 72 controls the drone 40 to fly in front of the camera 20 at a calibration distance according to position and orientation information of the camera 20 and position information and a distance setting rule of the drone 40. The drone 40 may fly in a single plane, multiple planes, or in multiple angles, as long as the drone 40 flies in front of the camera 20 at the calibration distance. The distance setting rule defines the calibration distance between the drone 40 and the camera 20, the calibration distance enabling the camera 20 to capture the complete identification pattern 50. The distance setting rule includes an initial calibration distance, such as 2 meters, of the drone 40 located in front of the camera 20.

In one embodiment, the path control module 72 includes a path planning unit 80 and a flight control unit 82. The path planning unit 80 plans a flight path of the drone 40 according to a preset rule according to the position and orientation information of the camera 20 and the position information of the drone 40. The position and orientation information of the camera 20 may be stored in the memory 62, or may be acquired from an electronic map and an orientation sensor. The preset rule defines a direction, a sequence and a distance in which the drone 40 is flying in each plane. The direction, the sequence and the distance of flight of the drone 40 in different planes at the same calibration distance may be the same or different. The flight control unit 82 controls the drone 40 to fly at the calibration distance in accordance with the flight path. In another embodiment, the path control module 72 is disposed on a hand-held remote control of the drone 40 to control the flight of the drone 40 according to a user's operation on the hand-held remote control.

The drone 40 flies in a plurality of flight positions at the calibration distance. The camera control module 74 controls the camera 20 to acquire at least one image of the identification pattern 50 when the drone 40 is in each of the flight positions. The identification patterns 50 in the plurality of images are superimposed to occupy a shooting range of the camera 20.

The calibration module 76 obtains the parameters of the camera 20 by performing calibration on the camera 20 according to the acquired plurality of images. The determination module 78 determines whether the acquired parameters meet a preset standard. Specifically, when an error between coordinates of the identification pattern 50 in the acquired plurality of images according to the parameters and actual coordinates of the identification pattern 50 is within a preset error range, the parameters are determined to meet the preset standard. When the error between the coordinates of the identification pattern 50 in the acquired plurality of images and the actual coordinates of the identification pattern 50 is not within the preset error range, it is determined that the parameters do not meet the preset standard.

The distance setting rule includes increasing the calibration distance between the camera 20 and the drone 40 when the parameters do not conform to the preset standard. The path control module 72 controls the drone 40 to fly a displacement amount away from the camera 20 according to the distance setting rule when the parameters do not meet the preset standard. Then, the camera control module 74 controls the camera 20 to capture a plurality of images of the identification pattern 50 at the displacement amount. The calibration distance is increased until the parameters meet the preset standard and calibration of the camera 20 is completed.

The determination module 78 determines if all of the cameras 20 have been calibrated. If not all of the cameras 20 have been calibrated, the path control module 72 controls the drone 40 to fly in front of another uncalibrated camera 20 to calibrate the next uncalibrated camera 20. When all of the cameras 20 have been calibrated, the path control module 72 controls the drone 40 to fly to a predetermined location and stop flying.

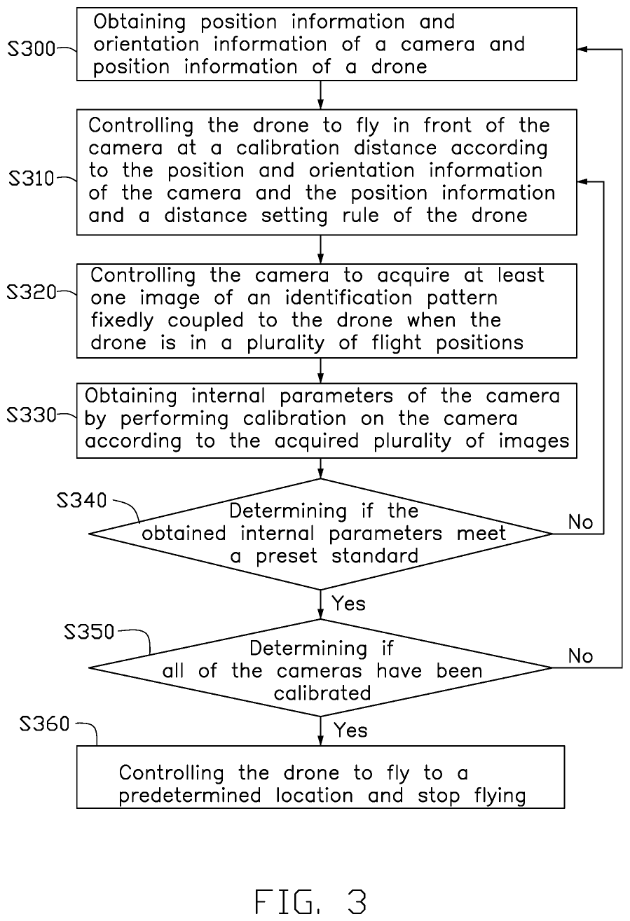

FIG. 3 shows a flowchart of a camera calibration method. The method is provided by way of embodiment, as there are a variety of ways to carry out the method. The method described below can be carried out using the configurations illustrated in FIGS. 1-2, for example, and various elements of these figures are referenced in explaining the example method. Each block shown in FIG. 3 represents one or more processes, methods, or subroutines carried out in the example method. Furthermore, the illustrated order of blocks is by example only, and the order of the blocks can be changed. Additional blocks can be added or fewer blocks can be utilized, without departing from this disclosure.

At block S300, position information and orientation information of a camera 20 and position information of the drone 40 are obtained. The drone 40 is coupled to the identification pattern 50.

At block S310, the path control module 72 controls the drone 40 to fly in front of the camera 20 at a calibration distance according to position and orientation information of the camera 20 and position information and a distance setting rule of the drone 40. The drone 40 may fly in a single plane, a multi-plane, or a multi-angle flight, as long as the drone 40 flies in front of the camera 20 at the calibration distance. The distance setting rule defines the calibration distance between the drone 40 and the camera 20, the calibration distance enabling the camera 20 to capture the complete identification pattern 50. The distance setting rule includes an initial calibration distance, such as 2 meters, of the drone 40 located in front of the camera 20.

At block S320, the camera control module 74 controls the camera 20 to acquire at least one image of the identification pattern 50 when the drone 40 is in each of the flight positions. The identification patterns 50 in the plurality of images are superimposed to occupy a shooting range of the camera 20.

At block S330, the calibration module 76 obtains the parameters of the camera 20 by performing calibration on the camera 20 according to the acquired plurality of images.

At block S340, the determination module 78 determines if the obtained parameters meet the preset standard. If the obtained parameters meet the preset standard, block S350 is implemented. If the obtained parameters do not meet the preset standard, block S310 is implemented. The distance setting rule includes increasing the calibration distance between the camera 20 and the drone 40 if the parameters do not meet the preset standard.

At block S350, the determination module 78 determines if all of the cameras 20 have been calibrated. If not all of the cameras 20 have been calibrated, block S300 is implemented, and the drone 40 is controlled to fly in front of another uncalibrated camera 20. If all of the cameras 20 have been calibrated, block S360 is implemented.

Step S360: The path control module 72 controls the drone 40 to fly to a predetermined location and stop flying.

The camera calibration system 100 and the camera calibration method are used to move the identification pattern 50 to different positions by flying the drone 40. Thus, it is not necessary to manually set a plurality of identification patterns 50 at different positions, which saves time and labor costs.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. A camera calibration system comprising:
a server;
a camera communicatively coupled to the server;
a drone communicatively coupled to the server; and
an identification pattern coupled to the drone; wherein the server:
controls the drone to fly at a calibration distance according to position and orientation information of the camera and position information and a distance setting rule of the drone, wherein the drone flies in a plurality of positions at the calibration distance and flies in at least one plane;
controls the camera to acquire at least one image of the identification pattern at each of the plurality of positions; and
obtains parameters of the camera by performing calibration on the camera according to the acquired plurality of images.

2. The camera calibration system of claim 1, wherein the server:
determines if the obtained parameters meet a preset standard; and
controls the drone to fly a displacement amount away from the camera according to the distance setting rule when the parameters do not meet the preset standard.

3. The camera calibration system of claim 1, wherein:
the identification patterns in the plurality of images are superimposed to occupy a shooting range of the camera.

4. The camera calibration system of claim 1, wherein:
the drone is controlled to fly in multiple planes and in multiple angles.

5. The camera calibration system of claim 4, wherein:
the server plans a flight path of the drone according to a preset rule according to the position and orientation information of the camera and the position information of the drone;
the preset rule defines a direction, a sequence, and a distance in which the drone flies in each plane.

6. A camera calibration method comprising:
obtaining position information and orientation information of a camera and position information of a drone, the drone coupled to an identification pattern;
controlling the drone to fly in front of the camera at a calibration distance according to the position and orientation information of the camera and the position information and a distance setting rule of the drone, wherein the drone flies in a plurality of positions at the calibration distance and flies in at least one plane;
controlling the camera to acquire at least one image of the identification pattern when the drone is in each of the flight positions; and
obtaining parameters of the camera by performing calibration on the camera according to the acquired plurality of images.

7. The camera calibration method of claim 6, wherein the method further comprises:
determining if the obtained parameters meet a preset standard; and
controlling the drone to fly a displacement amount away from the camera according to the distance setting rule when the parameters do not meet the preset standard.

8. The camera calibration method of claim 6, wherein:
the identification patterns in the plurality of images are superimposed to occupy a shooting range of the camera.

9. The camera calibration method of claim 6, wherein:
the drone is controlled to fly in multiple planes and in multiple angles.

10. The camera calibration method of claim 9, wherein:
the server plans a flight path of the drone according to a preset rule according to the position and orientation information of the camera and the position information of the drone;
the preset rule defines a direction, a sequence, and a distance in which the drone flies in each plane.

11. A non-transitory storage medium having stored thereon instructions that, when executed by a processor of a computing device, causes the processor to execute instructions of a camera calibration method, the method comprising:
obtaining position information and orientation information of a camera and position information of a drone, the drone coupled to an identification pattern;
controlling the drone to fly in front of the camera at a calibration distance according to the position and orientation information of the camera and the position information and a distance setting rule of the drone, wherein the drone flies in a plurality of positions at the calibration distance and flies in at least one plane;
controlling the camera to acquire at least one image of the identification pattern when the drone is in each of the flight positions; and
obtaining parameters of the camera by performing calibration on the camera according to the acquired plurality of images.

12. The non-transitory storage medium of claim 11, wherein the method further comprises:
determining if the obtained parameters meet a preset standard; and
controlling the drone to fly a displacement amount away from the camera according to the distance setting rule when the parameters do not meet the preset standard.

13. The non-transitory storage medium of claim 11, wherein:
the identification patterns in the plurality of images are superimposed to occupy a shooting range of the camera.

14. The non-transitory storage medium of claim 11, wherein:
the drone is controlled to fly in multiple planes and in multiple angles.

15. The non-transitory storage medium of claim 14, wherein:
the server plans a flight path of the drone according to a preset rule according to the position and orientation information of the camera and the position information of the drone;
the preset rule defines a direction, a sequence, and a distance in which the drone flies in each plane.
